(19) United States
(12) Patent Application Publication
(10) Pub. No.: US 2024/0347260 A1
(43) Pub. Date: Oct. 17, 2024

(54) COIL COMPONENT

(71) Applicant: SAMSUNG ELECTRO-MECHANICS CO., LTD., Suwon-si (KR)

(72) Inventors: Ic Seob KIM, Suwon-si (KR); Seung Ho HAN, Suwon-si (KR); Tai Yon CHO, Suwon-si (KR); In Young KANG, Suwon-si (KR); Seok Hwan AHN, Suwon-si (KR); Sung Hwan PARK, Suwon-si (KR)

(73) Assignee: SAMSUNG ELECTRO-MECHANICS CO., LTD., Suwon-si (KR)

(21) Appl. No.: 18/583,085

(22) Filed: Feb. 21, 2024

(30) Foreign Application Priority Data
Apr. 13, 2023 (KR) 10-2023-0048896

(51) Int. Cl. H01F 27/28; H01F 5/04

(52) U.S. Cl. CPC H01F 27/2852; H01F 2005/043

(57) ABSTRACT

A coil component of the present disclosure includes: a body; a coil embedded in the body, and including a lead-out portion; an external electrode disposed on one surface of the body; and a via electrode penetrating through the body and connecting the lead-out portion and the external electrode, in which the via electrode includes a conductive resin layer and a metal layer connected to the conductive resin layer.

### CROSS-REFERENCE TO RELATED APPLICATION(S)

This application claims the benefit of priority to Korean Patent Application No. 10-2023-0048896, filed on Apr. 13, 2023 in the Korean Intellectual Property Office, the disclosure of which is incorporated herein by reference in its entirety.

### TECHNICAL FIELD

The present disclosure relates to a coil component.

### BACKGROUND

An inductor, a type of coil component, is a representative passive electronic component used in electronic devices, along with a resistor and a capacitor.

As electronic devices become increasingly miniaturized, multifunctionalized, and implemented with high performance, an inductor is also required to be miniaturized, and at the same time, demand for an inductor which does not decrease capacitance due to miniaturization is increasing.

In order to minimize the decrease in capacitance due to such miniaturization, it is necessary to maximize a volume of a magnetic material in the inductor. In addition, in terms of power consumption efficiency, an inductor with low direct current resistance (R_{dc}) is required.

### SUMMARY

An aspect of the present disclosure is to provide a coil component with a low direct current resistance (R_{dc}) value.

Another aspect of the present disclosure is to provide a coil component having high inductance by minimizing a loss of magnetic material.

According to an aspect of the present disclosure, a coil component includes: a body; a coil embedded in the body, and including a lead-out portion; an external electrode disposed on one surface of the body; and a via electrode penetrating through the body and connecting the lead-out portion and the external electrode, in which the via electrode includes a conductive resin layer and a metal layer connected to the conductive resin layer.

According to another aspect of the present disclosure, a coil component includes: a body; a coil embedded in the body, and including a lead-out portion; an external electrode disposed on one surface of the body; and a via electrode penetrating through the body and connecting the lead-out portion and the external electrode, in which the via electrode includes a silver (Ag) layer and a copper (Cu) layer connected to the silver (Ag) layer.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a diagram schematically illustrating a coil component according to a first embodiment of the present disclosure;

FIG. 2 is a diagram illustrating a disassembled coil;

FIG. 3 is a diagram illustrating a cross-section taken along line I-I′ of FIG. 1;

FIG. 4 is a diagram schematically illustrating a coil component according to a second embodiment of the present disclosure;

FIG. 5 is a diagram illustrating a cross-section taken along line II-II′ of FIG. 4;

FIG. 6 is a diagram schematically illustrating a coil component according to a third embodiment of the present disclosure; and

FIG. 7 is a diagram schematically illustrating a coil component according to a fourth embodiment of the present disclosure.

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity-direction.

The term “coupled to,” “combined to,” and the like, may not only indicate that elements are directly and physically in contact with each other, but also include the configuration in which the other element is interposed between the elements such that the elements are also in contact with the other component.

In the drawings, sizes and thicknesses of elements illustrated in the drawings are indicated as examples for ease of description, and example embodiments in the present disclosure are not limited thereto.

In the drawings, an X-direction may be defined as a first direction or an L direction, a Y-direction may be a second direction or a W direction, and a Z-direction may be a third direction or a T direction.

In the descriptions described with reference to the accompanied drawings, the same elements or elements corresponding to each other will be described using the same reference numerals, and overlapping descriptions will not be repeated.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a GHz bead, a common mode filter, and the like.

### First Embodiment

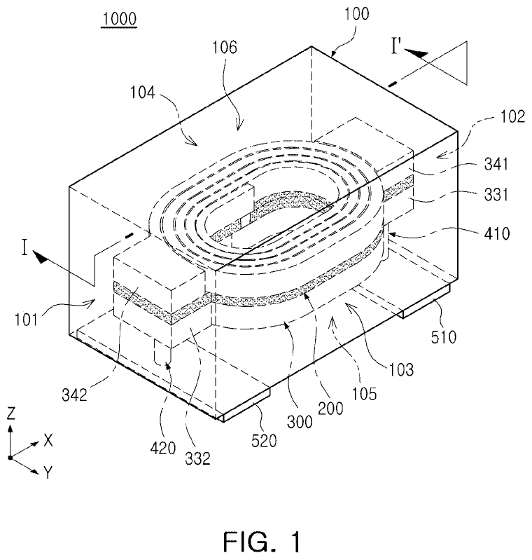

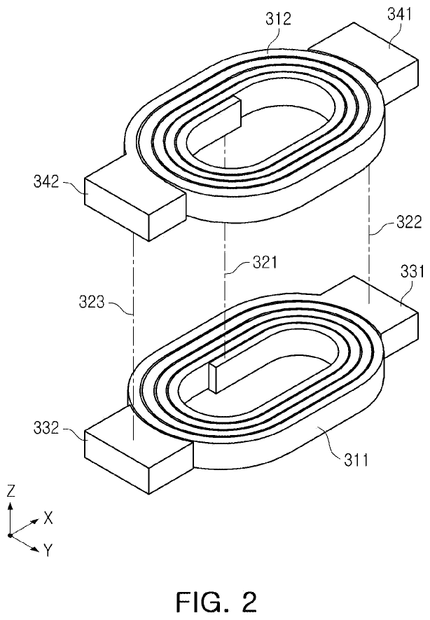

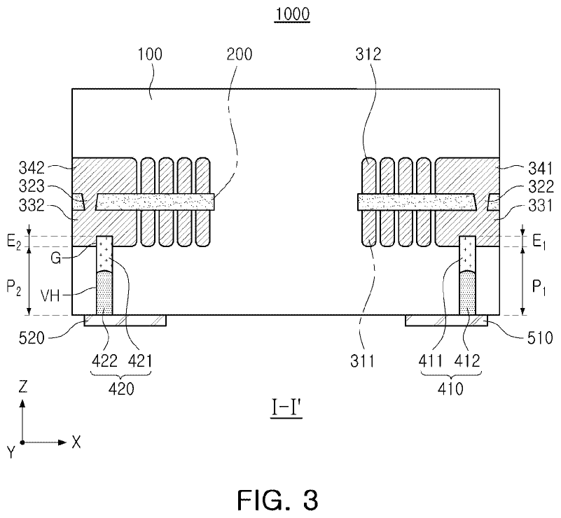

FIG. 1 is a diagram schematically illustrating a coil component according to a first embodiment of the present disclosure. FIG. 2 is a diagram illustrating a disassembled coil. FIG. 3 is a diagram illustrating a cross-section taken along line I-I′ of FIG. 1.

Referring to FIGS. 1 to 3, a coil component 1000 according to an embodiment of the present disclosure may include a body 100, a support member 200, a coil 300, a via electrode 400, and an external electrode 500.

The body 100 forms an exterior of the coil component 1000 according to this embodiment, and the coil 300 is embedded in the body 100.

The body 100 may be formed in a hexahedral shape as a whole.

Based on FIGS. 1 and 2, the body 100 includes a first surface 101 and a second surface 102, opposing each other, in an X-direction, a third surface 103 and a fourth surface 104, opposing each other in a Y-direction, and a fifth surface 105 and a sixth surface 106, opposing each other in a Z-direction. Each of the first to fourth surfaces 101, 102, 103 and 104 of the body 100 corresponds to a wall surface of the body 100 connecting the fifth surface 105 to the sixth surface 106 of the body 100. Hereinafter, both end surfaces of the body 100 may refer to the first surface 101 and the second surface 102 of the body 100, both side surfaces of the body 100 may refer to the third surface 103 and the fourth surface 104 of the body 100, and one surface (lower surface) of the body 100 and the other surface (upper surface) may refer to the fifth surface 105 and the sixth surface 106 of the body 100.

The body 100 may, for example, be formed so that the coil component 1000 according to the present embodiment in which an external electrode 500 described below is formed has a length of 2.0 mm, a width of 1.2 mm, and a thickness of 0.65 mm, but the present disclosure is not limited to thereto.

The body 100 may include a resin and a magnetic material. Specifically, the body 100 may be formed by stacking at least one magnetic composite sheet in which a magnetic material is dispersed in the resin. The magnetic material may be ferrite or magnetic metal powder particles. Examples of the ferrite powder particles may include, for example, at least one of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, and a Li-based ferrite. The magnetic metal powder particles may include at least one selected from a group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles. The magnetic metal powder particles may be amorphous or crystalline. For example, the magnetic metal powder particles may be a Fe—Si—B—Cr-based amorphous alloy powder particles, but the present disclosure is not limited thereto. Each of the ferrite and the magnetic metal powder particles may have an average diameter of about 0.1 μm to 30 μm, but the present disclosure is not limited thereto. The body 100 may include two or more types of magnetic materials dispersed in the resin. Here, the fact that magnetic materials are of different types denotes that magnetic materials dispersed in the resin are distinguished from each other by at least one of average diameter, a composition, crystallinity, and a shape. The insulating resin may include epoxy, polyimide, a liquid crystal polymer, alone or in combination, but the present disclosure is not limited thereto.

The body 100 includes a core 110 penetrating through a coil 300 to be described below. The core 110 may be formed by filling a through-hole of the coil 300 with a magnetic composite sheet, but the present disclosure is not limited thereto.

The support member 200 is embedded in the body 100, and serves to support the coil 300 to be described below.

The support member 200 may be formed of an insulating material including a thermosetting insulating resin such as an epoxy resin, a thermoplastic insulating resin such as polyimide, or a photosensitive insulating resin, and the support member 200 may be formed of an insulating material in which a reinforcing material such as a glass fiber or an inorganic filler is impregnated in the insulating resin. For example, the support member 200 may be formed of an insulating material such as prepreg, an Ajinomoto Build-up Film (ABF), FR-4, a Bismaleimide Triazine (BT) resin, and photo imageable dielectric (PID), but the present disclosure is not limited thereto.

The inorganic filler may include at least one selected from a group consisting of silica (SiO₂), alumina (Al₂O₃), silicon carbide (SiC), barium sulfate (BaSO₄), talc, mud, mica powder particles, aluminum hydroxide (Al(OH)₃), and magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide more excellent rigidity. When the support member 200 is formed of an insulating material that does not include glass fibers, the support member 200 may be advantageous in thinning a thickness of the component. When the support member 200 is formed of an insulating material including a photosensitive insulating resin, the number of processes for forming the coil 300 may be reduced, which may be advantageous in reducing production costs and may be advantageous in forming micro vias.

The coil 300 is embedded in the body 100, to express the characteristic of the coil component. For example, when the coil component 1000 of the present embodiment is used as a power inductor, the coil 300 may serve to stabilize the power of the electronic device by storing an electrical field as a magnetic field and maintaining an output voltage.

The coil 300 may include winding portions 311 and 312, vias 321, 322, and 323, lead-out portions 331 and 332, and auxiliary lead-out portions 341 and 342.

Specifically, with reference to FIG. 3, a first winding portion 311, a first lead-out portion 331, and a second lead-out portion 332 may be disposed on a lower surface of the support member 200 opposing the fifth surface 105 of the body 100, and a second winding portion 312, a first auxiliary lead-out portion 341, and a second auxiliary lead-out portion 342 may be disposed on an upper surface of the support member 200 opposing the lower surface of the support member 200.

Referring to FIGS. 2 and 3, the first winding portion 311 may be in contact with and connected to the first lead-out portion 331, and the first winding portion 311 and the first lead-out portion 331 may be spaced apart from the second lead-out portion 332, on the lower surface of the support member 200. In addition, the second winding portion 312 may be in contact with and connected to the second auxiliary lead-out portion 342, and the second winding portion 312 and the second auxiliary lead-out portion 342 may be spaced apart from the first auxiliary lead-out portion 341, on the upper surface of the support member 200.

That is, the first winding portion 311 may be connected to the first lead-out portion 331, and the second winding portion 312 may be connected to the second lead-out portion 332 through the second auxiliary lead-out portion 342. Meanwhile, since the first auxiliary lead-out portion 341 is unrelated to an electrical connection between the remaining components of the coil 300, which may be omitted in the present disclosure.

The first via 321 may penetrate through the support member 200 and be in contact with the first winding portion 311 and the second winding portion 312, respectively, the second via 322 may penetrate through the support member 200 and be in contact with the first lead-out portion 331 and the first auxiliary lead-out portion 341, respectively, and the third via 323 may penetrate through the support member 200 and be in contact with the second lead-out portion 332 and the second auxiliary lead-out portion 342, respectively. Thereby, the coil 300 may function as one coil as a whole.

Each of the first winding portion 311 and the second winding portion 312 may be in a form of a planar spiral in which at least one turn is formed using the core 110 as an axis. As an example, the first winding portion 311 may form at least one turn about the core 110 as an axis on the lower surface of the support member 200.

The lead-out portions 331 and 332 and the auxiliary lead-out portions 341 and 342 may be exposed to both end surfaces 101 and 102 of the body 100, respectively. That is, the first lead-out portion 331 may be exposed to the second surface 102 of the body 100, and the second lead-out portion 332 may be exposed to the first surface 101 of the body 100. In addition, the first auxiliary lead-out portion 341 may be exposed to the second surface 102 of the body 100, and the second auxiliary lead-out portion 342 may be exposed to the first surface 101 of the body 100.

At least one of the winding portions 311 and 312, vias 321, 322, and 323, the lead-out portions 331 and 332, and the auxiliary lead-out portions 341 and 342 may include at least one conductive layer.

For example, the winding portions 311 and 312, the lead-out portions 331 and 332, the auxiliary lead-out portions 341 and 342, and the vias 321, 322, and 323 are formed by plating on one surface or the other surface of the support member 200, each of the winding portions 311 and 312, the lead-out portions 331 and 332, the auxiliary lead-out portions 341 and 342, and the vias 321, 322, and 323 may include a seed layer such as an electroless plating layer, or the like, and an electroplating layer. That is, the coil component 1000 according to the present embodiment may be a thin film-type coil component, and the coil 300 may be formed as a coil-shaped pattern respectively formed on both surfaces of the support member 200. Here, the electroplating layer may have a single layer structure or a multilayer structure. The electroplating layer having a multilayer structure may be formed in a conformal film structure in which one electroplating layer is covered by another electroplating layer, and may be formed in a shape in which another electroplating layer is stacked only on one surface of any electroplating layer. A seed layer of the winding portions 311 and 312, a seed layer of the lead-out portions 331 and 332, a seed layer of the auxiliary lead-out portions 341 and 342, and a seed layer of the vias 321, 322, and 323 may be formed integrally with each other, so that no boundary may be formed therebetween, but the present disclosure is not limited thereto. An electroplating layer of the winding portions 311 and 312, an electroplating layer of the lead-out portions 331 and 332, an electroplating layer of the auxiliary lead-out portions 341 and 342, and an electroplating layer of the vias 321, 322, and 323 may be formed integrally with each other, so that no boundary may be formed therebetween, but the present disclosure is not limited thereto.

With reference to FIG. 3, the winding portions 311 and 312, the lead-out portions 331 and 332, and the auxiliary lead-out portions 341 and 342 may be formed to protrude from the lower and upper surfaces of the support member 200, respectively.

Each of the winding portions 311 and 312, the lead-out portions 331 and 332, the auxiliary lead-out portions 341 and 342, and the vias 321, 322, and 323 may be formed of a conductive material such as copper (Cu), aluminum (Al), silver (Ag), tin (Sn), gold (Au), nickel (Ni), lead (Pb), titanium (Ti), chromium (Cr), or alloys thereof, but the present disclosure is not limited thereto.

An external electrode is disposed on one surface (fifth surface) of the body 100. Specifically, first and second external electrodes 510 and 520 may be disposed on one surface (fifth surface) of the body 100 to be spaced apart from each other.

The external electrodes 510 and 520 may be formed in a single layer or multilayer structure. As an example, the external electrodes 510 and 520 may be formed of a first layer including copper (Cu), a second layer disposed on the first layer and including nickel (Ni), and a third layer disposed on the second layer, and including tin (Sn). As another example, the external electrodes 510 and 520 may include a resin electrode including conductive powder particles and a resin, and a plating layer formed on the resin electrode by plating. The first layer of the external electrodes 510 and 520 may be formed integrally with metal layers 412 and 422 extending on one surface (fifth surface) of the body 100, and no boundary may be formed therebetween. This will be explained in detail later.

The first and second external electrodes 510 and 520 are connected to via electrodes 410 and 420, to be described later, so that when the coil component is mounted on an electronic device, the coil within the coil component serves to be electrically connected to the electronic device.

The via electrodes 410 and 420 penetrate through a portion of the body 100 and connect the first and second external electrodes 510 and 520 and the first and second lead-out portions 331 and 332. Specifically, the first via electrode 410 connects the first external electrode 510 and the first lead-out portion 331, and the second via electrode 420 connects the second external electrode 520 and the second lead-out portion 332. By connecting the coil 300 and the external electrodes 510 and 520 to the via electrodes 410 and 420 in this manner, a coil component having high inductance can be implemented by minimizing a loss of the magnetic body.

The via electrodes 410 and 420 may be formed by drilling a via hole VH in the body 100 and forming a conductive material within the via hole VH. Here, drilling includes not only mechanical drilling using a drill bit, but also laser drilling using a laser.

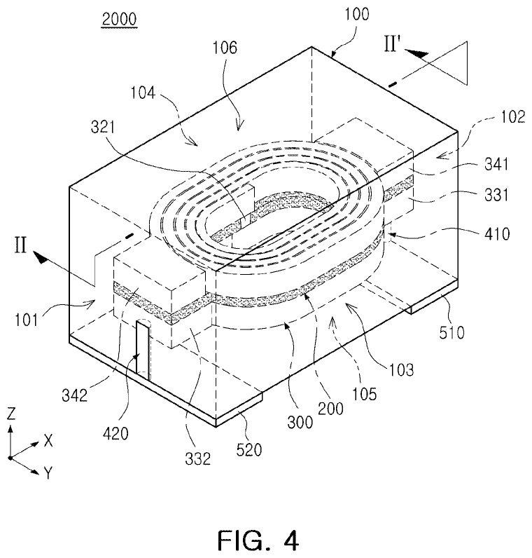

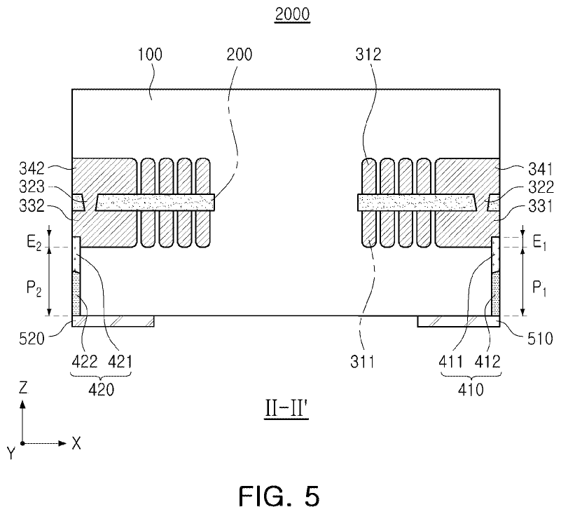

The via electrodes 410 and 420 include conductive resin layers 411 and 421 and metal layers 421 and 422. For convenience, in FIGS. 1 and 4, the via electrodes 410 and 420 are shown as a single layer structure. However, as shown in FIGS. 2 and 5, the via electrodes 410 and 420 illustrate a multilayer structure of the conductive resin layers 411 and 421 and the metal layers 421 and 422.

At least a portion of side surfaces of the conductive resin layers 411 and 421 and the metal layers 421 and 422 may be in contact with the body 100, respectively.

The conductive resin layers 411 and 421 may be in contact with the lead-out portions 331 and 332, and the metal layers 412 and 422 may be in contact with the external electrodes 510 and 520, so that the lead-out portions 331 and 332 and the external electrodes 510 and 520 may be connected to each other through the via electrodes 410 and 420.

Conductive resin layers 411 and 421 may be disposed between the lead-out portions 331 and 332 and the metal layers 412 and 422. That is, it may be connected in an order of the lead-out portions 331 and 332, the conductive resin layers 411 and 421, the metal layers 412 and 422, and the external electrodes 510 and 520, interfaces between the conductive resin layers 411 and 421 and the metal layers 412 and 422 may be convex toward the lead-out portions 331 and 332, respectively. However, it is not necessarily limited thereto, and the interface between the conductive resin layers 411 and 421 and the metal layers 412 and 422 may be concave in the direction of the lead-out portions 331 and 332.

The boundary between the metal layers 412 and 422 and the conductive resin layers 411 and 421 may be confirmed in the following manner. A sample of an X-direction-Z-direction or a Y-direction-Z-direction cut surface penetrating through the via electrodes 410 and 420 of the coil component 1000 according to the present embodiment is collected. When observing the collected sample using a scanning electron microscope (SEM), electron probe micro-analysis (EPMA) mapping analysis, or the like, a boundary line may be confirmed in a region in which the conductive resin layers 411 and 421 and the metal layers 412 and 422 are in contact, and the boundary line between the conductive resin layers 411 and 421 and the metal layers 412 and 422 may be convex or concave in the direction of the lead-out portions 331 and 332.

The metal layers 412 and 422 may extend to one surface (fifth surface) of the body 100. In this case, the metal layers 412 and 422 may extend to one surface (fifth surface) of the body 100 and be formed integrally with a first layer of the external electrodes 510 and 520 without a boundary. That is, since the metal layer and the first layer of the external electrodes may commonly include copper (Cu), a metal layer and a first layer of the external electrodes can be formed within the same plating process. In this case, the plating process can be simplified. A method of forming the via electrodes 410 and 420 is, for example, as follows.

First, a via hole VH is processed in the body 100 and the coil 300 by drilling. In this case, the processed via hole VH may penetrate through a portion of the body 100 and the lead-out portions 331 and 332 of the coil 300. Next, a portion of the processed via hole VH is filled with a conductive paste, and a method such as screen printing, or the like may be used. After filling a portion of the via hole VH with the conductive paste, a conductive paste layer can be formed by low-temperature heat treatment (heat treatment in a range of 150 to 200° C. for about 30 to 60 minutes) or sintering the same. The remaining via holes VH may be filled with metal through plating, and a method such as electrolytic plating, or the like may be used.

The via hole VH may have various aspect ratios (AR). The higher the aspect ratio (AR), the more difficult fill plating becomes and defects such as voids occur. Therefore, when forming via electrodes 410 and 420 with a high aspect ratio (AR), if the entire via hole (VH) is via fill electroplated, a void is formed inside the via, which may cause an electrical short-circuit. In the case of the present disclosure, a portion of the via hole VH is filled with a conductive paste through a process such as screen printing, or the like, and the remaining portion thereof is electroplated, which not only facilitates via fill but also achieves a high aspect ratio (AR) of the via hole VH. The conductive paste may be an Ag paste, and specifically, may include silver (Ag) particles, silver (Ag)-coated copper (Cu), and silver (Ag)-coated nickel (Ni) as conductive metals. However, it is not necessarily limited thereto, and the conductive metal may be metal powder particles that can be used as a common conductive material such as tin (Sn) or bismuth (Bi).

The conductive resin layers 411 and 421 and the metal layers 412 and 422 may be formed of different materials. Specifically, the conductive resin layers 411 and 421 may include silver (Ag), and the metal layers 412 and 422 may include copper (Cu). In other words, the via electrodes 410 and 420 may include a silver (Ag) layer and a copper (Cu) layer connected to the silver (Ag) layer.

Specific resistance of silver (Ag) and copper (Cu) is 1.724×10⁻⁸ Ωm, 1.60×10⁻⁸ Ωm, respectively, and since silver (Ag) bas a resistance value about 7% lower than that of copper (Cu), a portion of the via hole VH is substituted for (Cu), direct current resistance (R_{dc}) can be lowered.

The via electrodes 410 and 420 include penetrating portions P₁ and P₂ penetrating through a portion of the body 100 and extension portions E₁ and E₂ extending inwardly of the lead-out portions 331 and 332 from the penetrating portions P₁ and P₂.

A groove G maybe formed on one surface (lower surface) of the lead-out portions 331 and 332 opposing one surface (fifth surface) of the body 100. The groove G may be formed by extending the via hole VH formed in the body 100 to form via electrodes 410 and 420 inwardly of the lead-out portions 331 and 332.

The penetrating portions Pᵢ and P₂ and the extension portions E₁ and E₂ may not have a boundary formed therebetween, but the present disclosure is not limited thereto.

Conductive resin layers 411 and 421 may extend inwardly of the groove G of the lead-out portions 331 and 332. Furthermore, at least a portion of side surfaces of the conductive resin layers 411 and 421 may be in contact with the lead-out portions 331 and 332. As described above, this may be a result of the via electrodes 410 and 420 including extension portions E₁ and E₂ extending inwardly of the lead-out portions 331 and 332.

The side surfaces of the conductive resin layers 411 and 421 and the metal layers 412 and 422 may contact the body 100. As described above, this may be a result that the via electrodes 410 and 420 include penetrating portions P₁ and P₂ penetrating through a portion of the body 100.

The metal layers 412 and 422 may contact external electrodes 510 and 520. Thereby, the external electrodes 510 and 520 may be connected to the coil 300 inside the coil component through the conductive resin layer and the metal layer 411, 421, 412, and 422.

The first via electrode 410 and a second via conductor 720 may be formed symmetrically in the coil component 1000, but the present disclosure is not limited thereto. Specifically, the first and second via electrodes 410 and 420 may have a symmetrical relationship, based on a Y-direction-Z-direction cross-section passing through a center of the body 100 in the X-direction and an X-direction-Z-direction cross-section passing a center of the body 100 in the Y-direction, but the present disclosure is not limited thereto. As an example, the first and second via electrodes 410 and 420 may not satisfy the symmetrical relationship based on the Y-direction-Z-direction cross-section passing through the center of the body 100 in the X-direction, and may not satisfy the symmetrical relationship based on the X-direction-Z-direction cross-section passing through the center of the body 100 in the Y-direction.

### Second Embodiment

FIG. 4 is a diagram schematically illustrating a coil component according to a second embodiment of the present disclosure. FIG. 5 is a diagram illustrating a cross-section taken along line II-II′ of FIG. 4.

Hereinafter, a coil component 2000 according to the second embodiment will be described with reference to FIGS. 4 and 5, and differences from the coil component 1000 according to the first embodiment will be described in detail.

A via electrode of the coil component 2000 according to the second embodiment may extend to end surfaces of the body 100. Specifically, as illustrated in FIGS. 4 and 5, via electrodes 410 and 420 extend to a second surface 102 (a second end surface) and a first surface 101 (a first end surface) of the body 100, respectively. This is a design to reduce the number of via holes VH processed, and may be a result of vias being cut. That is, one via electrode may be distributed to two different adjacent chips, when individual chips are cut. With the above-described design, the process may be simplified by reducing the number of via holes processed.

The conductive resin layers 411 and 421 may extend to the second end surface and the first end surface of the body 100, respectively, and the metal layers 421 and 422 may extend to the second end surface and the first end surface of the body 100, respectively.

Other contents are substantially the same as those described above in the description of the first embodiment, so detailed descriptions will be omitted.

### Third Embodiment

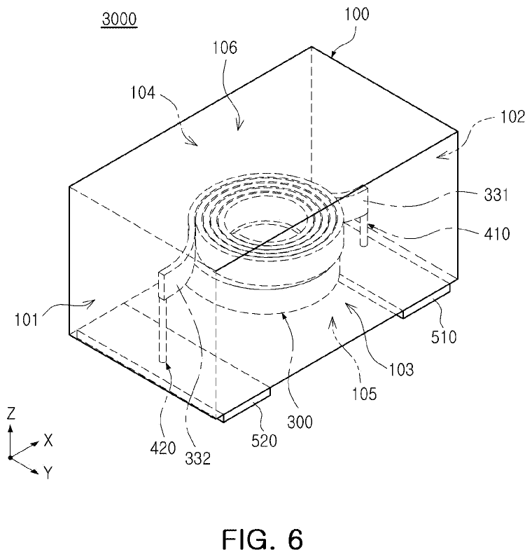

FIG. 6 is a diagram schematically illustrating a coil component according to a third embodiment of the present disclosure.

Referring to FIG. 6, a coil component 3000 according to the third embodiment of the present disclosure is different from the first embodiment, in the presence or absence of a wound-type coil. Therefore, in describing the coil component 3000 according to the present embodiment, only the wound-type coil, different from that of the first embodiment will be described. As for the remaining configuration of the present embodiment, the description in the first embodiment of the present disclosure can be applied as it is.

Referring to FIG. 6, a coil 300 of the coil component 3000 according to the third embodiment of the present disclosure may be a wound-type coil. The wound-type coil 300 is embedded inside the body 100. The wound-type coil 300 may be formed by winding a metal wire, such as a copper wire (Cu wire) of which a surface is covered with an insulating material, in a spiral shape. In addition, the wound-type coil 300 includes first and second lead-out portions 331 and 332 at both ends, and is connected to the external electrodes 510 and 520 through the first and second lead-out portions 331 and 332 and the via electrodes 410 and 420.

A description of other configurations overlaps with the description in the first embodiment and will therefore be omitted hereinafter.

### Fourth Embodiment

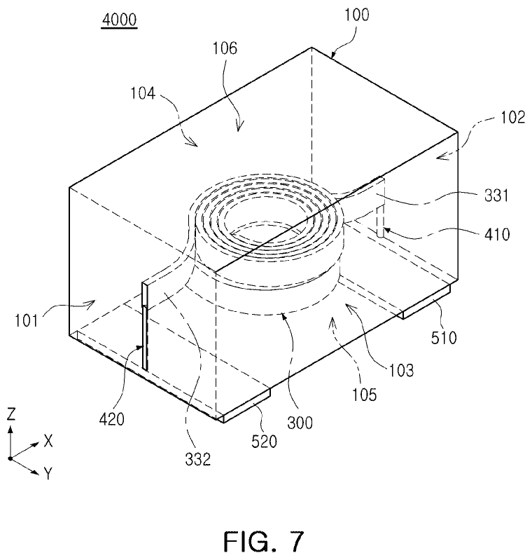

FIG. 7 is a diagram schematically illustrating a coil component according to a fourth embodiment of the present disclosure.

Referring to FIG. 7, a coil component 4000 according to the fourth embodiment of the present disclosure is different from the second embodiment, in the presence or absence of a wound-type coil. Therefore, in described the coil component 4000, only the wound-type coil, different from that in the second embodiment will be described. As for the remaining configuration of the present embodiment, the description in the second embodiment of the present disclosure may be applied as is.

Referring to FIG. 7, a coil 300 of the coil component 4000 according to the fourth embodiment of the present may be a wound-type coil. The same wound-type coil 300 as described in the third embodiment may be embedded inside the body 100, and the following description overlaps with the description in the third embodiment and will therefore be omitted.

A description of components other than the wound-type coil 300 overlaps with the description in the second embodiment and will be omitted hereinafter.

As set forth above, according to the present disclosure, a direct current resistance (R_{dc}) value of a coil component may be reduced. In addition, according to the present disclosure, it is possible to secure high inductance by minimizing loss of a magnetic material of the coil component.

Although one example embodiment of the present disclosure has been described above, it will be apparent to those skilled in the art that modifications and variations could be made in various ways by adding, changing, or deleting components within the scope of the patent claim, without departing from the scope of the present invention as defined by the appended claims, and will also be included within the scope of the present invention.

What is claimed is:

1. A coil component, comprising:
a body;
a coil embedded in the body, and including a lead-out portion;
an external electrode disposed on one surface of the body; and
a via electrode penetrating through the body and connecting the lead-out portion and the external electrode,
wherein the via electrode includes a conductive resin layer and a metal layer connected to the conductive resin layer.

2. The coil component of claim 1, wherein side surfaces of the metal layer and the conductive resin layer are at least partially in contact with the body.

3. The coil component of claim 2, wherein the conductive resin layer is in contact with the lead-out portion, and the metal layer is in contact with the external electrode.

4. The coil component of claim 3, wherein the conductive resin layer is disposed between the lead-out portion and the metal layer.

5. The coil component of claim 4, wherein an interface between the conductive resin layer and the metal layer is convex toward the lead-out portion.

6. The coil component of claim 4, wherein the metal layer extends to the one surface of the body.

7. The coil component of claim 4, wherein a groove is formed on one surface of the lead-out portion, and
the conductive resin layer extends inwardly of the groove of the lead-out portion.

8. The coil component of claim 7, wherein at least a portion of the side surface of the conductive resin layer is in contact with the lead-out portion.

9. The coil component of claim 1, wherein the via electrode extends to a first end surface or a second end surface of the body that is connected to the one surface of the body.

10. The coil component of claim 9, wherein the conductive resin layer extends to the first end surface or the second end surface of the body, and
the metal layer extends to the first end surface or the second end surface of the body.

11. The coil component of claim 1, further comprising:
a support member embedded in the body to support the coil,
wherein the lead-out portion includes first and second lead-out portions,
the external electrode includes first and second external electrodes,
the first and second external electrodes are disposed on the one surface of the body to be spaced apart from each other, and
the first and second lead-out portions are disposed to be spaced apart from each other on one surface of the support member facing the one surface of the body.

12. The coil component of claim 11, wherein the coil further comprises:
a first winding portion disposed on the one surface of the support member so as to contact the first lead-out portion, but spaced apart from the second lead-out portion;
a second winding portion disposed on another surface of the support member opposing the one surface of the support member; and
a via penetrating through the support member to connect the first winding portion and the second winding portion.

13. The coil component of claim 12, wherein the coil further comprises
an auxiliary lead-out portion disposed on the other surface of the support member and connecting the second winding portion and the second lead-out portion.

14. The coil component of claim 13, wherein the auxiliary lead-out portion includes a first auxiliary lead-out portion and a second auxiliary lead-out portion on the other surface of the support member,
the second winding portion is in contact with and connected to the second auxiliary lead-out portion, and
the second winding portion and the second auxiliary lead-out portion are spaced apart from the first auxiliary lead-out portion on the other surface of the support member.

15. The coil component of claim 14, wherein the via includes a first via, a second via, and a third via,
the first via penetrates through the support member to be in contact with the first winding portion and the second winding portion,
the second via penetrates through the support member to be in contact with the first lead-out portion and the first auxiliary lead-out portion, and
the third via penetrates through the support member to be in contact with the second lead-out portion and the second auxiliary lead-out portion.

16. The coil component of claim 14, wherein the second lead-out portion and the second auxiliary lead-out portion are exposed to a first end surface of the body, and
the first lead-out portion and the first auxiliary lead-out portion are exposed to a second end surface of the body opposing the first end surface.

17. A coil component, comprising:
a body;
a coil embedded in the body, and including a lead-out portion;
an external electrode disposed on one surface of the body; and
a via electrode penetrating through the body and connecting the lead-out portion and the external electrode,
wherein the via electrode includes a silver (Ag) layer and a copper (Cu) layer connected to the silver (Ag) layer.

18. The coil component of claim 17, wherein the silver (Ag) layer comprises at least one selected from a group consisting of silver (Ag) particles, silver (Ag)-coated copper (Cu), and silver (Ag)-coated nickel.
